(19) United States
(12) Patent Application Publication
(10) Pub. No.: US 2010/0280946 A1
(43) Pub. Date: Nov. 4, 2010

(54) TRANSACTION AUTHORISATION SYSTEM

(75) Inventor: Timothy John Batten, North Sydney (AU)

Correspondence Address: BLAKELY SOKOLOFF TAYLOR & ZAFMAN LLP, 1279 OAKMEAD PARKWAY, SUNNYVALE, CA, 94085-4040, US

(73) Assignee: MPay Pty Limited, North Sydney, New South Wales (AU)

(21) Appl. No.: 12/063,570

(22) PCT Filed: Aug. 11, 2006
(86) PCT No.: PCT/AU06/01144

§ 371 Date: Feb. 11, 2008

(30) Foreign Application Priority Data
Aug. 11, 2005 (AU) 2005904327

(51) Int. Cl. G06Q 40/00; G06F 21/00

(52) U.S. Cl. 705/42; 705/44; 726/4

(57) ABSTRACT

A method and system is provided for authorizing an action on a resource such as an account, wherein the action requires the authority of an unauthenticated authorizing party. An authorization request is received at a trusted third party such as a bank from a requesting party. The authorization request includes a resource operator specifying said action and an identifier for providing an identifying link to said authorizing party. The authorization request is stored. A pre-existing authentication channel established between the authorizing party and the trusted third party is used to authenticate the authorizing party. The authorization request is provided to the authorizing party, and the authorization response can then be received from the authorizing party.

### FIELD OF THE INVENTION

The present invention relates to a method of providing an authenticated authorisation to a requesting party. In one aspect of the invention, as a result of an affirmative authenticated authorisation, the requesting party's access to a resource can be managed.

### BACKGROUND OF THE INVENTION

Currently, credit card purchases are the primary means of transacting consumer electronic transactions on the Internet, particularly ‘one off’ or single transactions. Matching the ever increasing popularity of the Internet as a medium for transactions is the incidence of credit card fraud associated with remote transactions conducted over the Internet.

In an effort to address these problems, a consortium of banks and credit card issuers developed a system known as Secure Electronic Transactions (SET) in 1998. However, this system has neither achieved critical mass amongst consumers or amongst merchants, in part due to difficulties in implementation. An alternate system has evolved known variously as ‘microcash’, ‘micropayments’ or ‘cybercash’, details of which are disclosed in U.S. Pat. No. 6,061,655 to Bahreman and U.S. Pat. No. 5,815,657 to Williams. However, this system has also not achieved widespread uptake again due to complexity and involvement of many parties and the need for consumers to adopt new technology and systems.

In the arena of ‘ongoing’ or recurrent transactions, routine payments by direct debit of a wide range of bills, from telephone bills to monthly mortgage payments of both fixed and variable amounts are the preferred means of receiving payment for many billers. The payment processing and remittance costs are low, the error rate is very low, and the cash flow is usually quite predictable as the payments are usually made automatically at the same time in each time period. One significant drawback in the direct debit system is for each direct debit, the payee is typically required to retain a signed paper copy of the debit authority, in order to comply with relevant legislation, regulations and/or codes of banking practice for the payee acquiring bank.

This leads to significant administrative overheads associated with storing and accessing a high volume of records, and consequent difficulty in initialising and reversing direct debit authorisations. Further, the paper-based nature of direct debit authorities makes it impractical to implement more sophisticated direct debit authorities (limits per month, limits per transaction etc).

Finally, many consumers do not like the direct debit system, as they feel that they lack control over the operation of their accounts, and if they change banks and/or accounts, it can be quite time consuming and difficult to untangle the various direct debiting arrangements. Particularly, many consumers are concerned by the lack of control over the date and amount of the direct debit, as well as the difficulty of reversing direct debit instructions.

In the area of pre-paid mobiles, when customers wish to increase their account balance, they typically purchase a voucher from a convenience store, petrol station, supermarket or the like. The vendor who sells the voucher usually charges the mobile network operator an agency fee of approximately ten percent of the value of the transaction. Furthermore, as many prepaid mobile customers are minors who may gain unauthorised access to their parent or guardian's credit card details, mobile network operators experience a high rate of credit reversals as transactions are disputed by card holders. Using a direct debit system for effecting payment of the pre-paid mobiles is not practical, as it would necessitate management and processing of over millions of direct debit requests for the prepaid mobile phones that are currently deployed in Australia alone.

From the perspective of the mobile network operator, the current system is not cost effective, is problematic and does not scale easily.

Any discussion of documents, publications, acts, devices, substances, articles, materials or the like which is included in the present specification has been done so for the sole purpose so as to provide a contextual basis for the present invention. Any such discussions are not to be understood as admission of subject matter which forms the prior art base, or any part of the common general knowledge of the relevant technical field in relation to the technical field of the present invention to which it extended at the priority date or dates of the present invention.

### SUMMARY OF THE INVENTION

In a broad aspect of the present invention there is provided a method for authorising an action on a resource, wherein said action requires the authority of an unauthenticated authorising party, said method comprising;

receiving an authorisation request at a trusted third party from a requesting party, the authorisation request including a resource operator specifying said action and an identifier for providing an identifying link to said authorising party;
storing said authorisation request;
using a pre-existing authentication channel established between the authorising party and the trusted third party to authenticate the authorising party;
providing the authorisation request to the authorising party; and receiving an authorisation response from the authorising party.

Preferably the authorisation response is received at the trusted third party via the authentication channel. The authorisation response may then transmitted from the trusted third party to the requesting party.

Alternatively, the authorisation response may be received at the requesting party directly from the authorising party.

Preferably the method includes validating and storing the authorisation response. The authorisation response may be validated and stored at the requesting party. Alternatively, the authorisation response may be stored at the trusted third party.

The resource may be held by the trusted third party on behalf of the authorising party. Advantageously the authorising party may be the resource controller.

Preferably the pre-existing authentication channel is established to perform secure transactions between the authorising party and the trusted third party, said transactions being unrelated to the action requiring the authority of the unauthenticated authorising party.

The requesting party and the authorising party may be different entities. Alternatively, the requesting party and the authorising party may be the same entity.

The authorisation request may be transmitted from a resource user to the requesting party for onward transmission to the trusted third party.

In a further aspect of the present invention there is provided a method for authorising an action on a resource held by a trusted third party on behalf of a resource controller, said method comprising:

receiving an authorisation request at the trusted third party from a requesting party, the authorisation request including a resource operator specifying said action and a resource identifier;
using a pre-existing authentication channel between the resource controller and the trusted third party to authenticate the resource controller;
providing the authorisation request to the authenticated resource controller; and
receiving an authorisation response from the resource controller through the authorisation channel at the trusted third party.

The authorisation response may be received at the trusted third party via the authentication channel. The authorisation response may then be transmitted to the requesting party.

The authorisation response may be received at the requesting party directly from the authorising party.

In a further aspect of the present invention there is provide a method for authorising an action on a first resource held by a resource holder, said method comprising:

receiving an authorisation request at a trusted third party from a requesting party, the authorisation request including a authorising party identifier and a resource operator specifying said action;
using a pre-existing authentication channel between the requesting party and the trusted third party to authenticate the requesting party;
providing the authorisation request to the authenticated authorising party; and receiving an authorisation response from the authorising party.

The resource may be an account held by a financial institution and the authorisation request may be a direct debit authorisation request.

In a further aspect of the present invention there is provided a method for authorising a requesting party to create a direct debit facility to increase the balance of a pre-paid resource account where the direct debit facility is associated with an account held by a financial institution on behalf of an account controller, said method comprising:

making a direct debit authorisation request available to the account controller using a pre-existing authentication channel established between the account controller and the financial institution; and
enabling the account controller to provide an authenticated authorisation response to the authorisation request.

The resource held by the trusted third party may be a monetary asset, and the authenticated authorisation request may provide or revoke authority to access or transfer at least some of the resource.

The authorisation request may include authorisations for recurrent operations having the same or different values. Advantageously the authorisation request may include rules governing the operation on the specified resource and verification data which enables the requesting party to verify that the authorisation request has not been altered.

In still a further aspect of the present invention there is provided a system for authorising an action on a resource, wherein said action requires the authority of an unauthenticated authorising party, said system comprising;

means for receiving from a requesting party an authorisation request at a trusted third party, the authorisation request including a resource operator specifying said action and an identifier for providing an identifying link to said authorising party;
a first storage means for storing said authorisation request;
means for providing the authorisation request to the authorising party using a pre-existing authentication channel established between the authorising party and the trusted third party to authenticate the authorising party, and
a second storage means for storing the authorisation response from the authorising party.

In still another aspect of the present invention there is provide a system for authorising a requesting party to transfer an amount of a money held by a trusted third party on behalf of a resource controller, said system comprising:

a pre-existing authentication protocol established between the resource controller and the trusted third party for making an authorisation request by the requesting party available to the resource controller;
means for enabling the resource controller to provide an authenticated response to the authorisation request.

The resource may be any resource to which there is controlled access, including monetary assets, non-monetary assets, services and information.

Where the resource held by the trusted third party is a monetary asset, means are provided to record the authenticated authorisation request providing or revoking authority to access at least some of the resource. Preferably the authority provided includes authority to transfer at least a part of the funds.

The resource may comprise funds held in an account, and in this case the resource controller may be the account controller or at least an account signatory who has access to the account. The trusted third party may be a bank, which holds funds in an account on behalf of the resource controller. In the case of monetary assets, the trusted third party may be a financial institution, a government agency, a building society, a brokerage firm, or any entity holding an account on behalf of the resource controller.

Preferably, the authorisation request includes means for including identification data capable of identifying the specific resource held by the trusted third party on behalf of the resource controller. The authorisation request may also include means for the provision of details of the resource and rules governing the operation on the specified resource. Further, the authorisation request may also include verification data which enables the requesting party to verify that the authorisation request has not been altered. Preferably there is also provided a storage means for storing the authorisation request and the authenticated authorisation received from the resource controller at the trusted third party.

The authentication process may be established directly with the trusted third party or mediated indirectly via resource access channel.

### BRIEF DESCRIPTION OF THE DRAWINGS

The present invention will now be described by way of non-limiting example with reference to the accompanying drawings in which:

FIG. 1 shows a high level system architecture diagram of the general process of indirect authorisation in accordance with a first embodiment of the present invention;

FIG. 2 shows a flowchart setting out the steps that are completed in the process of indirect authorisation shown in FIG. 1;

FIG. 3 shows a high level diagram of a direct debit embodiment of the present invention;

FIG. 4A shows a flow chart of the steps associated with the direct debit embodiment of FIG. 3:

FIGS. 4B-4J show screen shots that are an example of one way in which the direct debit embodiment of the present invention shown in FIG. 3 may be implemented;

FIG. 5 shows a high level architecture diagram of prepaid top up authorisation process according to a further embodiment of the present invention;

FIG. 6 shows a flowchart of the top up authorisation process of FIG. 5,

FIG. 7 shows a high level diagram of a further embodiment of the present invention for providing authenticated authorized access to a resource; and

FIG. 8 shows a flowchart of the authenticated authorisation process of FIG. 7.

### DETAILED DESCRIPTION OF THE EMBODIMENTS

It will also be understood that the term “comprises” (or its grammatical variants) as used in this specification is equivalent to the term “includes” and should not be taken as excluding the presence of other elements or features.

As used herein the term “requesting party” includes a person making a request directly or indirectly to the trusted third party. For example, the requesting party may include a merchant, a merchant service provider or a document service provider. In certain cases the requesting party may be the same as the authorising party, or may be an agent of the authorising party.

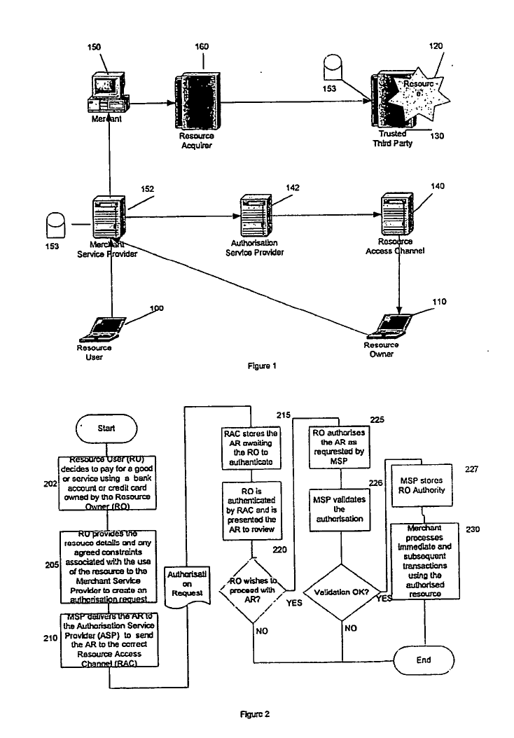

FIG. 1 shows a schematic representation of a system configured to implement a method for a requesting party (such as a merchant) to obtain an authority to initiate transfer of an amount of resource (such as funds) held by a trusted third party on behalf of a resource controller to a receiving party (or merchant) by a resource acquirer according to an embodiment of the present invention.

The system includes a resource user 100 and a resource authoriser or controller 110 who use and control (respectively) a resource such as funds 120. These funds are held on behalf of the resource controller by a trusted third party such as an issuing bank 130. Access to the resource by the resource controller is controlled through a pre-existing resource access channel 140. A merchant 150 supplies (or intends to supply) to the resource user goods and/or services, and may initiate a resource transfer request by contacting a resource acquirer 160 in the form of an acquiring bank. Based on the contract between the merchant and the resource acquirer, the merchant must have authority (or permission) from the resource controller to be able to ask the resource acquirer to acquire an amount of resource, in this case funds. The merchant uses a merchant service provider 152 to seek the authority to acquire an amount of resource; the merchant service provider in turn contacts an authorisation service provider 142 who determines to which resource access channel or trusted third party to direct the authorisation request. The resource access channel associates the authorisation request with the resource and makes available the authorisation request to the resource controller, either proactively or when next the resource controller uses the resource access channel.

The resource controller or authoriser 110, once authenticated by the resource access channel, may review the authorisation request from the merchant 150. To authorise the authorisation request, the resource controller provides the merchant service provider 152 with an authorisation, which contains sufficient information to allow the merchant service provider to confirm adequate authority by ensuring that the authorisation request was generated by the merchant and identifying the bank through which the authorisation request was presented back to the resource controller.

The merchant or the merchant service provider stores this authenticated authorisation request (now an authority) for later access should it be required by the resource acquirer in the date store 15. The data contained in the authority includes the resource user name, resource identifier (including numerical identifiers and other names used to clearly identify the account), the bank (by name and possible branch), the authority amount limit (if any), the period over which the authority limit applies, transaction amount limits (if any), the number of transactions authorised per period, the status of the authorisation request, a unique identifier of the authorisation request, and any secure codes, digital signatures and the like that have been attached to the authorisation request.

It would be appreciated by a person skilled in the art that the resource user and the resource controller may in some cases be the same entity. Furthermore, the merchant service provider and the merchant may also be the same entity; or the merchant service provider and the authorisation service provider may be the same entity. Finally, the authorisation service provider and resource access channel operations may all be provided by the same trusted third party 130.

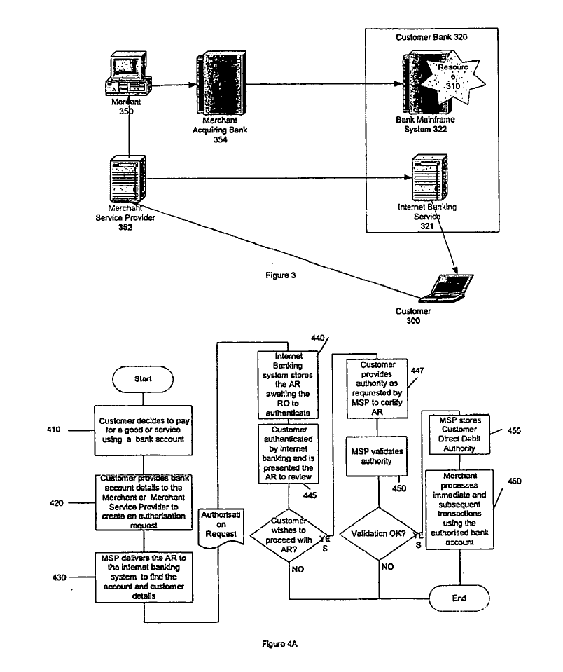

The steps of the typical process of indirect authentication are described in more detail with reference to FIG. 2.

As shown in step 202, a resource user 100 purchases a merchant's 150 goods and/or services, for example by using the internet. As set out in step 205, the resource user seeks to pay for the goods/services by using a financial resource owned by the resource controller in the form of funds in an account and provides the resource details and any constraints associated with the use of the resource to the merchant 150, or to the merchant service provider 152.

In step 210, the merchant 150 (or merchant service provider 152) sends an authorisation request 211 to the authorisation service provider 142 who identifies the resource access channel to which the resource nominated in the authorisation request relates.

In step 215 the resource access channel 140 (which in the present embodiment is a secure Internet Banking Site) associates the authorisation request with a resource identifier in the form of an account number. The resource access channel 140 then makes the authorisation request available to an authenticated resource controller to view using a bank message facility associated with the Internet Banking Site).

In step 220, a resource controller is shown as being able to access the authorisation request once successfully authenticated by the resource access channel. Access to the authorisation request relies on the pre-existing ‘strong’ authentication process which has been established between the resource controller and the trusted third party. This authentication relationship is established independently of both the requesting party and the existence of an authorisation request. The authentication relationship may be established by the resource controller at the time at which the secure internet banking facility is established under the control of the trusted third party after any accounts linked to the facility have been opened. All of this takes place in accordance with the bank's normal secure protocols relating to customer verification.

In step 225, should the resource controller wish to proceed with the authorisation request, the authorisation is passed back to the merchant service provider (or merchant). This authorisation may be validated by the merchant services provider in step 226.

If the verification data is correct, the authorisation request is now an authority, and the merchant stores the authority 227. The merchant may process the authority immediately or according to a schedule agreed to between the resource controller and resource user. Of course if the verification data is incorrect, no authority is assumed by the merchant service provider and the merchant may in turn notify the resource user or do nothing.

If the authority also includes information specifying that it is for ongoing resource acquisitions by the merchant in subsequent transactions occurring at later dates, the authority may be processed without the need for recurrent authorisations 230 such as with a direct debit authority.

The resource access channel may include a facility which enables an authenticated resource controller to review a list of current authorisations associated with the resource held by the trusted third party. This facility allows an authenticated resource controller to confirm or revoke authorities and thereby manage the resource on an ongoing basis.

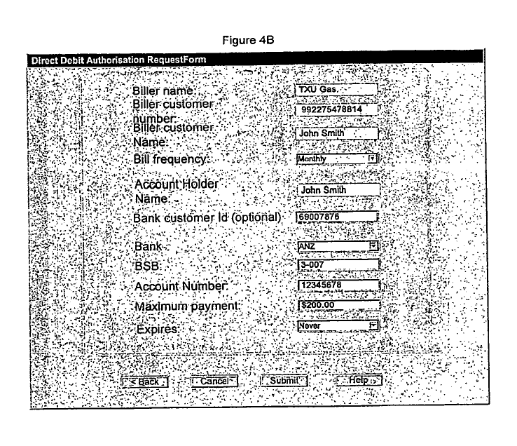

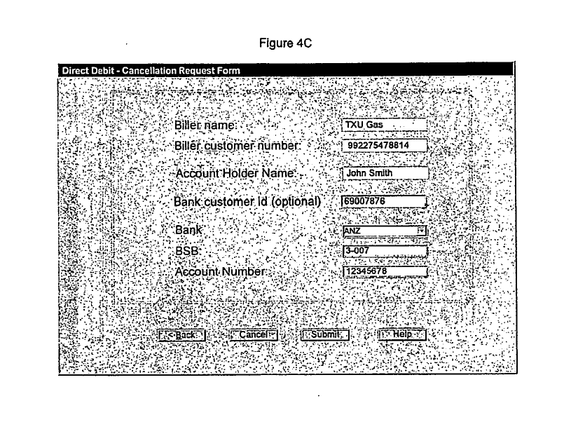

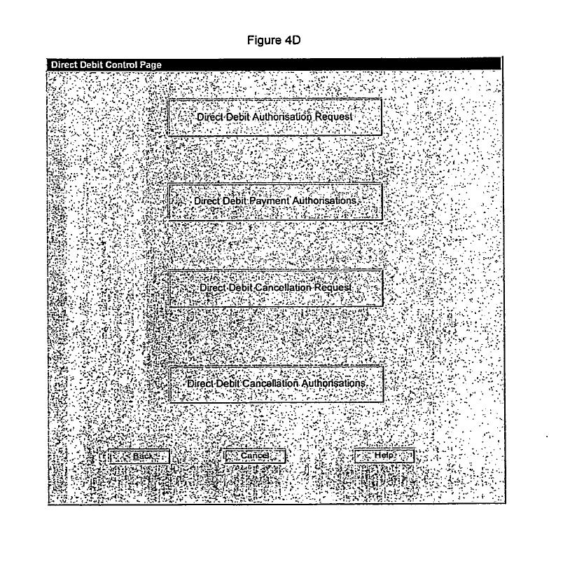

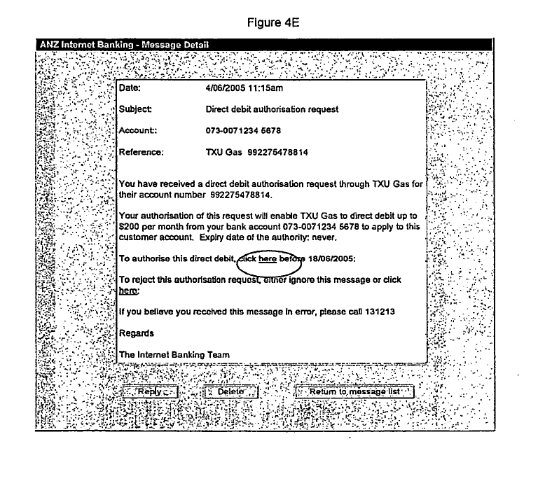

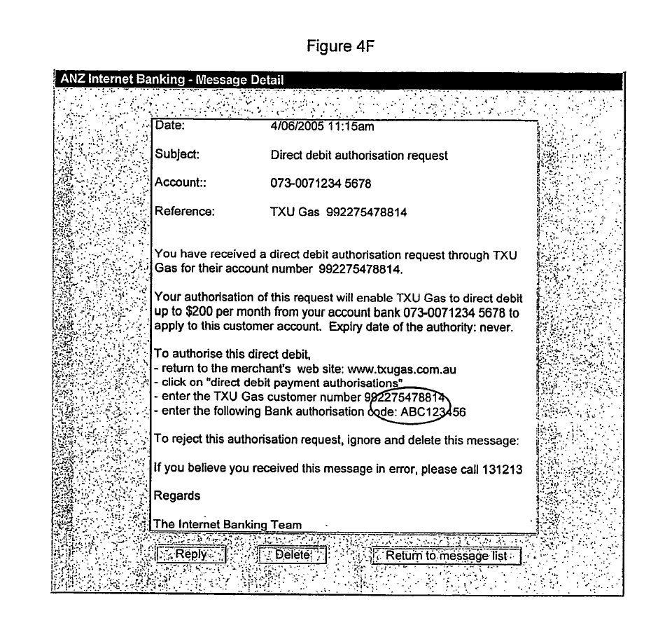

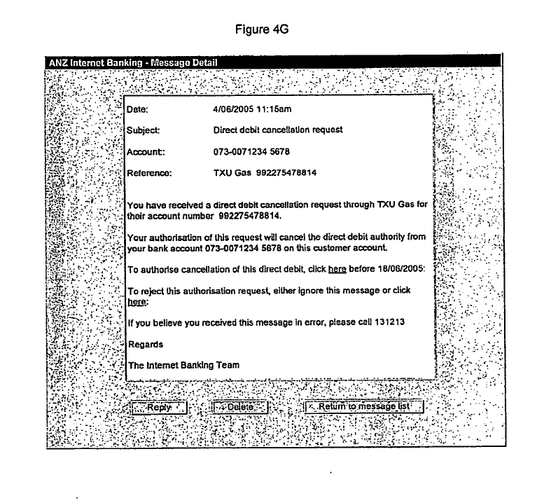

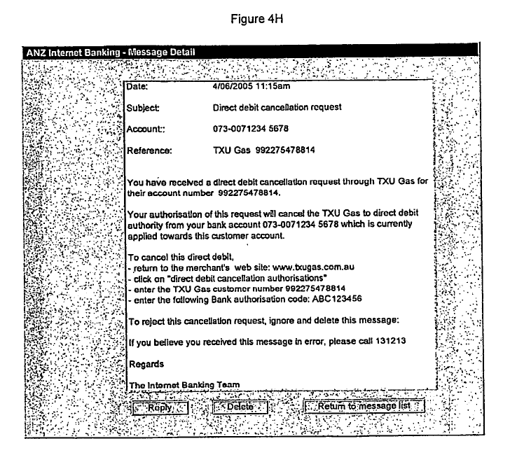

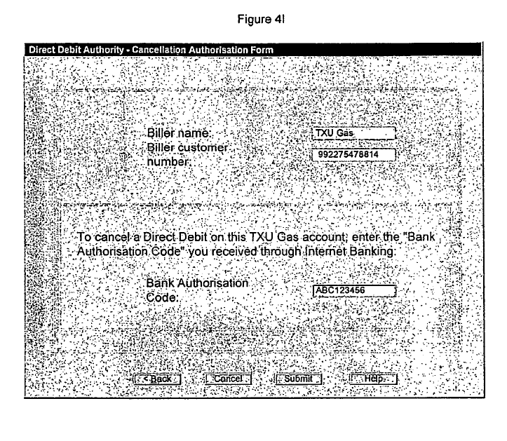

Turning to FIG. 3, a specific aspect of the invention in relation to direct debit authorities is described. In this case the following parties are involved: the customer 300, the bank 320 (and its associated internet banking system 321 and mainframe 322), the merchant 350, the merchant service provider 352 and the merchant acquiring bank 354. The steps involved in the direct debit system disclosed in FIG. 3 are set out below with reference to FIG. 4A and example screenshots shown in FIGS. 4B-4J.

In step 410, the customer accesses the merchant's bill payment service, for example by using the internet and selecting a payments page associated with the merchant. The merchant may be an electricity, gas, telephone or other utility provider, or any other biller utilising a direct debit payment facility. As is well known in the art the customer may provide a customer number and password to manage their account held with the service provider or alternately simply choose the payments option. Typically, a number of different channels for effecting payment are provided by a merchant, and the customer may choose to create or cancel a direct debit option.

Next, in step 420, once a direct debit option has been selected, a direct debit payment authorisation form may be pre-populated with some stored customer details (for example associated with the customer account number and other identification information provided by the customer to the merchant), as shown in FIG. 4B. Alternatively, a customer may simply select the option to pay for the goods/service using a direct debit authority and either the customer or the merchant may manually complete a form provided by the merchant by entering their account details an example of which is shown as the online form of FIG. 4B.

In either case, the customer provides their bank and account details and any additional rules for the direct debit authorisation request to the merchant. These rules may include specifying a limit per day, or other time period, and other descriptions outlining the rules of when the merchant has authority to operate the account.

Should the customer wish to cancel a previously created direct debit authority, they may provide biller details, including name, customer number, account details, and their bank customer identification number (if relevant), as shown in FIG. 4C.

Once a direct debit authorisation request has been created, the merchant contacts the customer's internet banking system at 430 and provides it with the authorisation request to pass on to the customer. In step 440, the authorisation request is associated with the customer's account and stored awaiting the customer accessing their bank account over the internet.

The authorisation request is only accessible to the customer after they have been authenticated to access internet banking using the existing authentication procedure which may involve a user name and password. Additional authentication approaches may be used either in conjunction with or as alternatives to the user name and password, including a digital certificate, challenge response, a one time password (eg via SMS, or a hardware or software token).

Once the customer has been authenticated, in step 445, the customer may be presented with a direct debit menu within their Internet banking site, an example of which is shown in FIG. 4D. As shown in FIG. 4D, the customer is able to select the options to action or review direct debit requests, cancellations and authorisations.

If the customer decides to review direct debit authorisation requests, they may be presented with direct debit authorisation requests similar to that shown by way of example in FIG. 4E or 4F. The direct debit authorisation requests may include details such as date, subject, account and reference details. The request may include a URL which when selected, may be capable of transmitting information to the merchants web site, including customer account number and limits, as well as an authority code; all signed by a bank secret (private) key, as is well known in the art using asymmetric encryption.

Alternatively, in the direct debit authorisation request for the creation of a direct debit authority, once authenticated, the customer may be provided with a direct debit authority code, shown in FIG. 4F with a value of ABC123456. This may represent a combination of ‘secret’ information provided by the merchant to the bank (eg ABC12) as well as a code generated by the bank (eg 3456). This authority code may then be provided by the customer manually entering it at the merchant's website.

The process for the cancellation of a direct debit authority may involve the presentation of screens with a similar format to the creation requests, cancellation screens being shown in FIGS. 4G and 4H. As shown, the cancellation requests may include either an direct debit authority cancellation code which can be manually entered by the customer at the merchant (4G), or in the alternative, a URL which operates similarly to that of FIG. 4E, being FIG. 4H.

In any of the above examples, should the customer wish to proceed with the creation/cancellation requests, the customer provides their authorisation to the merchant service provider in step 447 (either through selecting a link which posts the information, or in the alternative, manually entering the code). In the latter scenario, the customer may be presented with a form in which they are able to enter their details, as well as the bank authorisation code. An example form used for the cancellation and creation of a direct debit request in the latter scenario is shown in FIGS. 4I and 4J (respectively). As would be appreciated by a person skilled in the art, the information contained in the direct debit authorisation request may be partially obscured for security reasons.

Alternatively, should the customer not proceed with the authorisation request, it is ignored and may time-out.

Once the request has been authorised by the customer, the merchant verifies the authorised resource transfer request in step 450 by comparing sample data in the authorisation request received from the resource owner and the authorisation request sent by the merchant to the authorisation service provider. This may involve checking their secret information (in the present example ABC12) and that the bank's digital signature over the whole transaction is also valid (in the present example 3456) using the bank's public key.

If successfully verified, the merchant may then store the customer authorisation 452 and is able to act on the direct debit authority 460 with the merchant acquirer bank. If the details are not verified by the merchant, the merchant will not act on the direct debit creation or cancellation authorisation request.

In a further aspect, step 450 may involve the Merchant Service Provider validating the authority details as provided in the URL against the details in the initial Authorisation Request, and also validating the bank's digital signature using its public key.

In still a further embodiment of the present invention there is provided a method for increasing the balance of a prepaid mobile account.

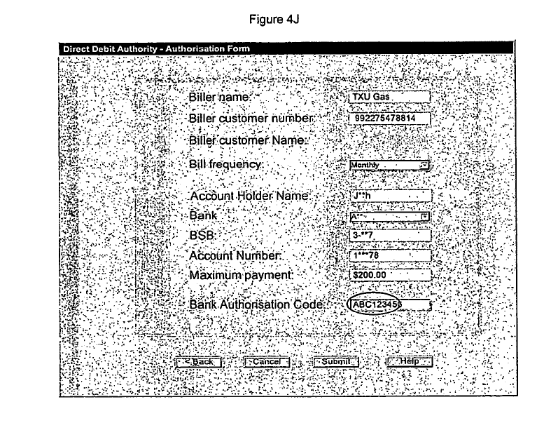

FIG. 5 shows a high level system architecture diagram setting out the entities involved in this embodiment—the mobile handset user 570, the bank customer or resource controller 500, the top up service provider 521, mobile network operator 520, mobile network operator acquiring bank 522, the trusted third party or bank 550 and the associated internet banking system 551 with the bank mainframe 552.

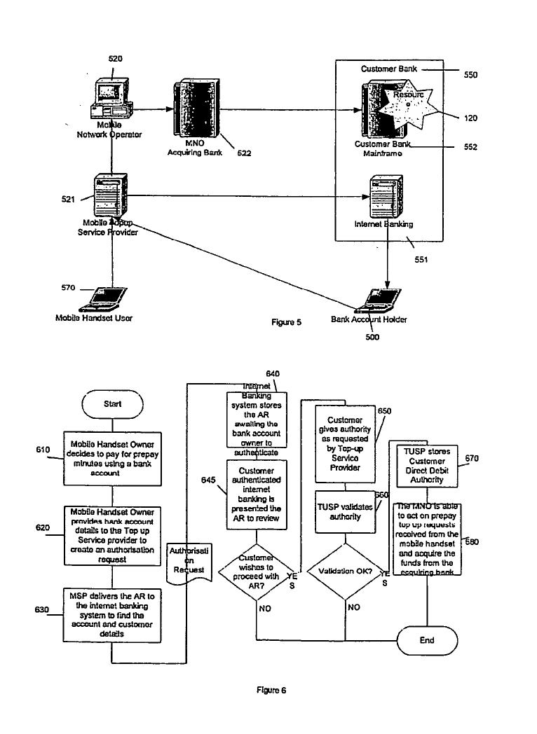

FIG. 6 is a flowchart setting out the steps involved in using the entities shown in FIG. 5. At step 610, the handset owner or bank customer accesses the prepaid top up service page (for example by accessing the service provider's website) and selects the “prepaid top-up” facility 620, filling out the bank and account number details to create an authorisation request.

Subsequently in step 630, the merchant contacts the customer's Internet banking system and transmits it the authorisation request provided by the customer to pass on to the customer.

In step 640, the authorisation request is associated with the customer's account and stored awaiting the customer to access internet banking. The authorisation request is only accessible to the customer after they have been authenticated to access Internet banking using the pre-existing authentication procedure established between the trusted third party or bank 550 and the customer for general internet banking purposes.

Once the customer has been authenticated in step 645, the customer is able to review the authorisation request. If the customer wishes to proceed with the authorisation request, it becomes an authority. The customer provides the authority to the merchant service provider in step 650. Alternatively, should the customer not proceed with the authorisation request, it is ignored and may time out.

Once the request has been authorised by the customer, the mobile network operator verifies the authority in step 660. The authority may be verified by the mobile network operator (e.g. by comparing sample data in the authority received from the customer with the authorisation request sent by the mobile network operator). If the authority is verified, the mobile network operator may then store the customer authorisation 680. The mobile network operator is then able to act on the direct debit authority 690 with the mobile network operator or acquirer bank. The mobile network operator can now accept instructions from the mobile handset to top up the value in the prepay account using the customer bank account.

In still a further embodiment of the present invention there is provided a method for authenticating the authorisation access to a resource held by a further party, using a relationship between a resource holder (in this case a bank account holder) and the trusted third party (a bank).

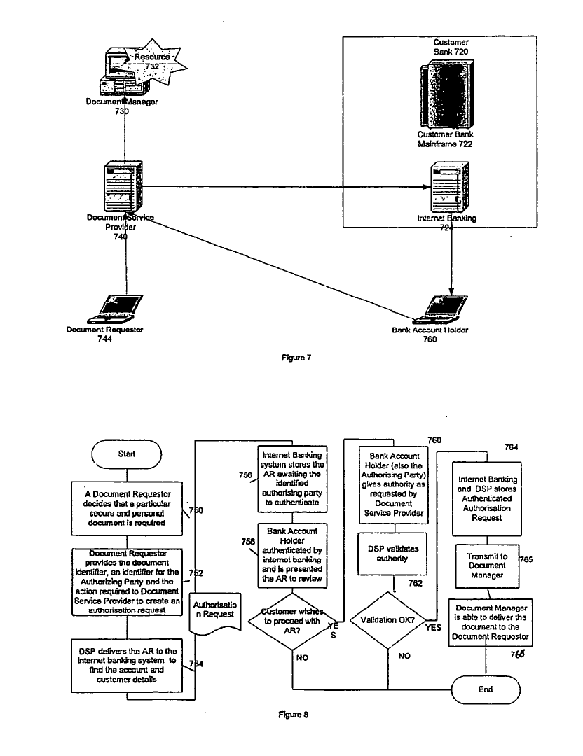

FIG. 7 shows a high level system architecture diagram setting out the respective entities that are involved in this embodiment. A bank account holder 710 holds a bank account with a financial institution such as a bank 720 (which has an associated customer bank mainframe 722 and customer internet banking facility 724). A document manager 730 holds a resource 732. A document service provider 740 acts as an intermediary and provides access to the resource 732 to a document requesting party 744.

FIG. 8 is a flowchart setting out the steps involved using the entities shown in FIG. 7. At step 750, a document requesting party 744 decides that particular document is required. At step 752 the document requesting party 744 provides an access authorisation request 753 to the document service provider 740. The authorisation request 753 typically includes a document identifier, an identifier for an authorising party and an indication of the action required. The authorisation request may also include a verification code chosen by the document service provider 740.

Next, in step 754, the document service provider 740 then delivers the authorisation request 753 to the internet banking system 724, which locates the relevant account and customer details based on the identifier of the authorising party provided. The authorisation request 753 is stored by the internet banking system 724 in step 726, awaiting authentication by the authorising party (in this case the account holder 740).

Subsequently, in step 758 the bank account holder 710 accesses their account and is presented with the authorisation request 753.

The bank account holder 754 accepts the authorisation request 753 in step 760, thereby creating an authorisation. The authorisation may be then transmitted directly to the document service provider 740. The transmission of the authorisation may be encrypted, for example by using the document service provider's public key. Alternatively, the authorisation may be transmitted back to the internet banking system 724, and the transmitted to the document service provider 740. The transmission to the document service provider 740 may be encrypted, for example using the bank's private key in an asymmetric cryptography system as is known in the art.

Next, in step 762, the document service provider 740 may validate the authorisation against the details of their initial authorisation request 753 using a verification code.

Assuming that the authorisation is validated in step 764 it may be then stored by either or both of the document service provider 740 or the bank 720. The authorisation is then transmitted 765 to the document manager 730.

Finally at step 766 the document manager is able to deliver the document to the document requestor 744 confident of the identity of the bank account holder, having received an authenticated authorisation via the document service provider 740 from the account holder.

It will be understood that the invention disclosed and defined in this specification extends to all alternative combinations of two or more of the individual features mentioned or evident from the text or drawings. All of these different combinations constitute various alternative aspects of the invention.

1. A method for authorising an action on a resource, wherein said action requires the authority of an unauthenticated authorising party, said method comprising:
receiving an authorisation request at a trusted third party from a requesting party, the authorisation request including a resource operator specifying said action and an identifier for providing an identifying link to said authorising party;
storing said authorisation request;
using a pre-existing authentication channel established between the authorising party and the trusted third party to authenticate the authorising party;
providing the authorisation request to the authorising party; and
receiving an authorisation response from the authorising party.

2. A method according to claim 1 wherein the authorisation response is received at the trusted third party via the authentication channel.

3. A method according to claim 2 further including transmission of the authorisation response from the trusted third party to the requesting party.

4. A method according to claim 1 wherein the authorisation response is received at the requesting party directly from the authorising party.

5. A method according to claim 1 which includes validating and storing the authorisation response.

6. A method according to claim 5 wherein the authorisation response is validated and stored with at least one of the requesting party and the trusted third party.

7-8. (canceled)

9. A method according to claim 1 wherein the pre-existing authentication channel is established to perform secure transactions between the authorising party and the trusted third party, said secure transactions being unrelated to the action requiring the authority of the unauthenticated authorising party.

10. A method according to claim 1 wherein the requesting party and the authorising party are the same entity.

11. A method according to claim 1 wherein the requesting party and the authorising party are different entities.

12. A method according to claim 8 wherein the authorising party is a resource controller, and the resource is held by the trusted third party on behalf of the authorising party.

13. A method according to claim 1 wherein the authorisation request is transmitted from a resource user to the requesting party for onward transmission to the trusted third party.

14. A method for authorising an action on a resource held by a trusted third party on behalf of a resource controller, said method comprising:
receiving an authorisation request at the trusted third party from a requesting party, the authorisation request including a resource operator specifying said action and a resource identifier;
using a pre-existing authentication channel between the resource controller and the trusted third party to authenticate the resource controller;
providing the authorisation request to the authenticated resource controller; and
receiving an authorisation response from the resource controller through the authorisation channel at the trusted third party.

15. (canceled)

16. A method according to claim 14 further including transmission of the authorisation response from the trusted third party to the requesting party.

17. A method according to claim 14 wherein the authorisation response is received at the requesting party directly from the authorising party.

18. (canceled)

19. A method according to claim 1 wherein the resource is an account held by a financial institution and the authorisation request is a direct debit authorisation request.

20. A method for authorising a requesting party to create a direct debit facility to increase the balance of a pre-paid resource account where the direct debit facility is associated with an account held by a financial institution on behalf of an account controller, said method comprising:
making a direct debit authorisation request available to the account controller using a pre-existing authentication channel established between the account controller and the financial institution; and
enabling the account controller to provide an authenticated authorisation response to the authorisation request.

21. A method according to claim 20 wherein the authenticated authorisation request either provides or revokes authority to access or transfer at least some of the funds in the resource account.

22. A method according to claim 20 in which the authorisation request includes authorisations for recurrent operations having the same or different values.

23. A method according to claim 20 in which the authorisation request includes rules governing the operation on the specified resource and verification data which enables the requesting party to verify that the authorisation request has not been altered.

24. A system for authorising an action on a resource, wherein said action requires the authority of an unauthenticated authorising party, said system comprising:
means for receiving from a requesting party an authorisation request at a trusted third party, the authorisation request including a resource operator specifying said action and an identifier for providing an identifying link to said authorising party;
a first data store for storing said authorisation request;
means for providing the authorisation request to the authorising party using a pre-existing authentication channel established between the authorising party and the trusted third party to authenticate the authorising party; and
a second data store for storing the authorisation response from the authorising party.

25. (canceled)

26. A computer system for authorising an action on a resource, wherein said action requires the authority of an unauthenticated authorising party, said computer system comprising a computational controller and a computer memory readable by the computational controller, the computer memory storing instructions readable by the controller to perform a method according to claim 1.

27. A computer readable medium having stored thereon executable instructions for causing a computer to perform a method according to claim 1.

28. A method for authorising a transfer of funds from an account held by a trusted third party on behalf of an account holder, said method comprising:
receiving an authorisation request at the trusted third party from a requesting party, the authorisation request including a resource operator specifying said funds transfer operation and an account identifier for identifying the account;
using a pre-existing authentication channel between the account holder and the trusted third party to authenticate the account holder;
providing the authorisation request to the authenticated account holder; and
receiving an authorisation response from the account holder through the authorisation channel at the trusted third party, and validating and storing the authorisation response.

29. A method according to claim 28 in which the requesting party is a mobile handset user, the request is channelled via a top-up service provider, and the transfer of funds from the account holder is for providing a top-up service to the mobile handset user.
